(19) United States
(12) Patent Application Publication
(10) Pub. No.: US 2001/0013090 A1
(43) Pub. Date: Aug. 9, 2001

(54) A MEMORY MANAGEMENT SYSTEM INCLUDING MAPPING OF PHYSICALLY NON-CONTIGUOUS MEMORY SEGMENTS INTO LOGICALLY CONTIGUOUS BLOCKS AND RELEASING OF MEMORY SEGMENTS BASED ON THE NUMBER OF REFERENCES AND SEGMENT OWNERSHIP

(76) Inventor: STEFAN SANDSTROM, LUND (SE)

Correspondence Address: Cary & Kelly, LLP, 1875 Charleston Rd., Mountain View, CA, 94043, US

(21) Appl. No.: 09/084,080

(22) Filed: May 22, 1998

(30) Foreign Application Priority Data
Jul. 16, 1997 (SE) 9702733-8

(51) Int. Cl. G06F 12/00

(52) U.S. Cl. 711/147; 709/203; 711/156

(57) ABSTRACT

A digital memory management system for providing access to a digital memory (20) from at least one program process executing in an operating system for at least one digital processor has at least one memory management object (30; 50, 60) with a mapping structure (32a, 32b) for mapping a plurality of physically non-contiguous memory segments (22a, 22b) into a logically contiguous memory block. A reference (41) to an owner (40; 40a, 40b) is given to each physically non-contiguous memory segment. Furthermore, at least one method is arranged for providing random access for the program processes to the logically contiguous memory block, and at least one memory reference handling method is arranged for monitoring the number of references from the program processes to each respective physically non-contiguous memory segments and is arranged to release any of the physically non-contiguous memory segments, when or if it is found not to be in use by any of the program processes.

### PRIORITY CLAIMED

This application claims the benefit of priority to Swedish Application No. 9702733-8, filed Jul. 16, 1997, entitled A Digital Memory Management System.

### BACKGROUND OF THE INVENTION

1. Technical Field

The present invention generally relates to digital memory management systems for digital processors, and in particular the present invention relates to digital memory management systems for use in real-time operating systems for dedicated network server applications, such as print servers, CD-servers, hard-disk servers, camera servers, etc.

2. Description of the Prior Art

The demand and market for dedicated network server applications of the types mentioned above have been the subject of rapid growth during the last decade. The most familiar example is the dedicated print servers, i.e. electronic devices which are connected to a network for providing printing-related services (such as printer queue handling) to the users of client computers also connected to the network. Other types of dedicated network servers, which have become increasingly popular during the last few years, are CD-servers (which enable a plurality of users to share one common CD-player via the network), hard-disk servers (which virtually act as a file server such as a Novell® Netware® server), fax servers (for providing incoming and outgoing telefacsimile services to the users) and, more recently, camera servers (for distributing digital snap-shot photographs among a plurality of network connected users).

In the following, the generic term dedicated network server is used for designating an electronic device, which according to the above is arranged to provide digital services to a plurality of users connected thereto by means of a network. Thus, a dedicated network server may be an arbitrary server of any of the types described above or of a similar type not explicitly mentioned herein. Furthermore, the term network is to be broadly interpreted as relating to conventional wire-based LAN networks (e.g. Ethernet or Token Ring), as well as wireless networks operating by means of e.g. radio links or infrared links, and WANs or global networks such as the Internet.

Most modern dedicated network servers use one or a plurality of digital processors, e.g. CPUs and/or DSPs. Furthermore, the server is provided with an operating system acting as an interface between hardware (the processor(s), auxiliary circuitry, memory circuits, etc.) and software (at least one program process executed by the processor(s) for performing the intended functionality of the server). In order to enhance the operating speed of the server as well as minimize the time and cost required for developing the program processes, it is highly desired to facilitate the production of small, efficient and compact program code.

A very frequent operation in dedicated network server applications is to collect and put together a logically consecutive block of data, typically consisting of 20-200 bytes but occasionally comprising up to 2-60 KB, so as to provide the block of data to the user application. Quite often, the data this block is to consist of is not consecutively stored in memory. On the contrary, the data is likely to be scattered in a plurality of small and mutually non-contiguous memory segments or fragments. A previously known approach to handle retrieval of scattered data is to perform the operation in two steps, wherein data is read from the various non-contiguous memory locations in the first step, so as to be copied to a consecutive memory block in the second step. The collected data may then be supplied to the process from which the request was made by reading the consecutive data stored in this contiguous memory block. The drawback of this approach is twofold; the total amount of memory required as well as the total CPU-load are increased.

Previous attempts to avoid the copying of memory required according to the approach above, by providing an abstraction that hides the scattering of the data, have resulted in serious difficulties in deciding whether a certain piece of memory is currently in use by any program process, or if it may be released for later re-use by another process.

### SUMMARY OF THE INVENTION

It is an object of the present invention to provide a more efficient solution to the problem of scattered data retrieval. The present invention is particularly aimed at providing a memory management system, in which the retrieval of scattered data may be performed with less memory and at a reduced CPU-load, as compared to the prior art approach.

The objects of the invention are achieved by a digital memory management system, which provides an abstraction that makes a number of scattered segments of memory appear as a logically consecutive memory block to a user, e.g. a program process, and which in addition keeps track of whether the various memory segments are used or not and notifies an owner, e.g. an object created by a certain process, of the current status (“in use”/“not in use”) of a given memory segment belonging to the owner.

According to a primary aspect of the present invention there is provided a digital memory management system for providing access to a digital memory from at least one program process executing in an operating system for at least one digital processor. The system comprises memory management objects with a mapping structure for mapping a plurality of physically non-contiguous memory segments into a logically contiguous memory block, wherein each physically non-contiguous memory segment has a reference to an owner, e.g. an object created by a program process, of the memory segment. Furthermore, the system has methods for providing random access for the program processes to the logically contiguous memory block, as well as memory reference handling methods for monitoring the number of references from the program processes to each respective physically non-contiguous memory segment. These memory reference handling methods are arranged to release any of the physically non-contiguous memory segments, when or if it is found not to be in use by any of the program processes.

### BRIEF DESCRIPTION OF THE DRAWINGS

The invention will be described in more detail in the following, reference being made to the accompanying drawings, in which:

FIG. 1 is a schematic illustration of an exemplary computer network system, comprising various different dedicated network servers, in which the digital memory management system according to the present invention may be applied,

FIG. 2 is a schematic view of the level of abstraction, or the mapping from physically non-contiguous to logically contiguous memory, provided by the digital memory management system according to the present invention,

FIG. 3 is a schematic view of a memory management object, which is a central element in the digital memory management system according to the present invention,

FIG. 4 illustrates a preferred embodiment of the memory management object in FIG. 3, and

FIG. 5 is a schematic view of a further developed abstraction hierarchy according to one aspect of the invention.

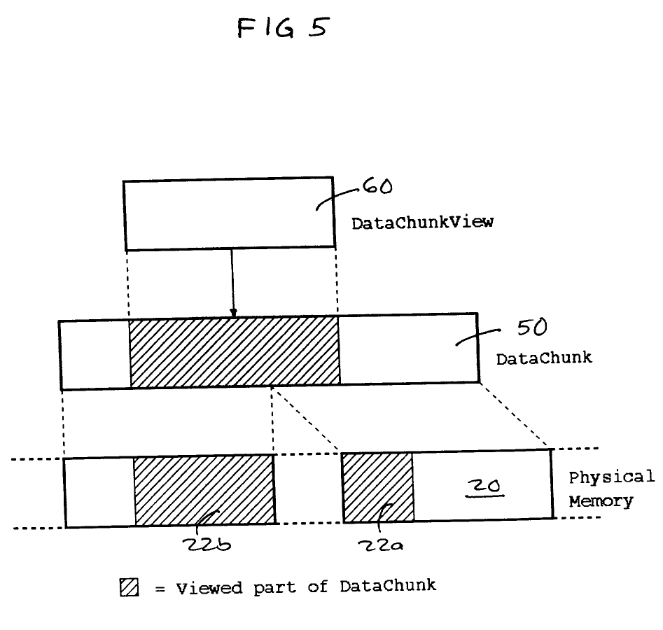

### DETAILED DISCLOSURE OF THE INVENTION

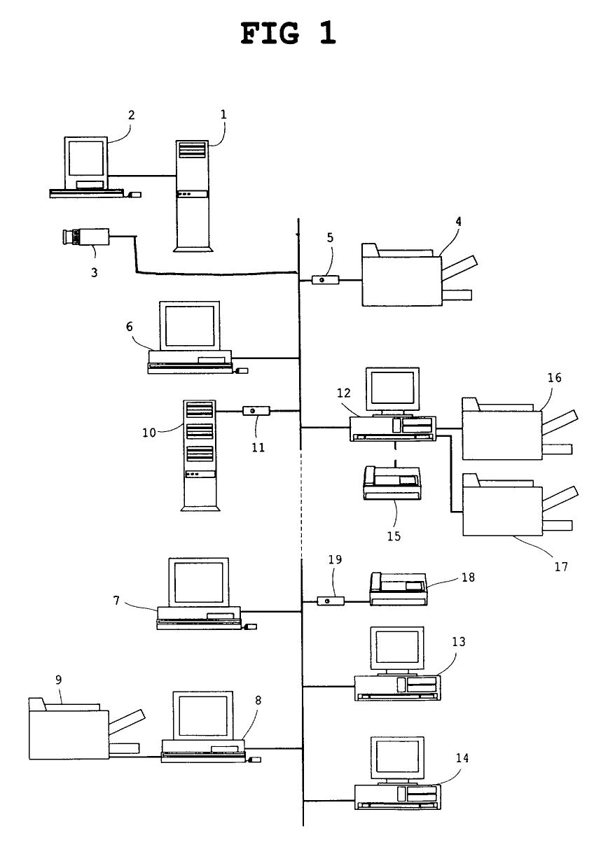

As already emphasized, the digital memory management system according to the invention may be used in many different kinds of networks. In FIG. 1 one of several possible computer network systems is shown for exemplifying but not limiting purposes. According to FIG. 1 the system comprises a file server 1 with a server terminal 2; a camera server 3; a network laser printer 4 connected to the network via a print server 5; workstations 6, 7 and 8, the latter with a local inkjet printer 9; a CD-ROM tower 10 connected to the network via a CD-ROM server 11; personal computers (PCs) 12, 13 and 14; a local fax 15, a local regular laser printer 16 and a local color laser printer 17 connected to computer 12; and a fax 18 connected to the network via a fax server 19.

Thus, the computer network system above comprises a plurality of dedicated network servers, namely the camera server 3, the print server 5, the CD-ROM server 11 and the fax server 19, all of which are possible environments for exercising the memory management system according to the invention.

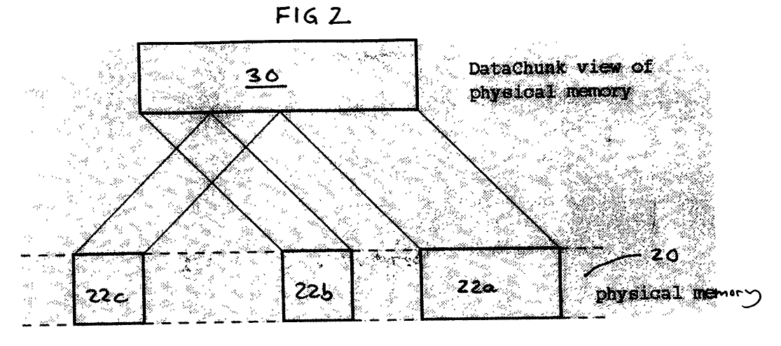

The features described above of the memory management system according to the invention are realized by means of memory management objects 30, which hereinafter will be referred to as Data Chunks. As illustrated in FIG. 2, a Data Chunk object 30 provides an abstraction of data, in such a way that for a user (i.e. a program process executing in the dedicated network server, or an object created by the program process), the Data Chunk 30 will appear to contain a contiguous block of memory, i.e. a consecutive sequence of memory addresses. In reality, however, the memory managed by the Data Chunk 30 is in fact scattered into several physical memory segments 22a, 22b, 22c, etc., of the physical RAM memory 20.

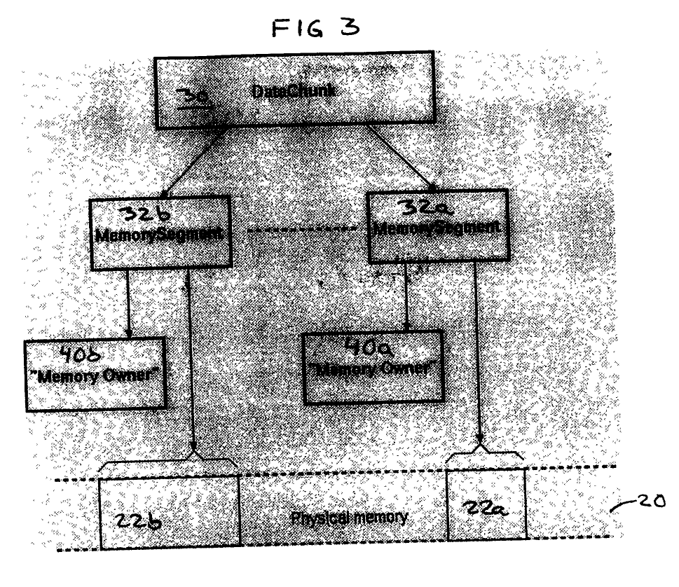

According to FIG. 3 a Data Chunk 30 points out a plurality of physical memory segments 22a, 22b, etc., and their respective owners 40a, 40b, etc., via a corresponding number of logical memory segments 32a, 32b, etc. The different memory segments are logically concatenated into a single consecutive memory block. New segments of data may be appended or prepended to a Data Chunk, as will be described in more detail below.

Each memory segment 22a/32a, 22b/32b, etc., has an owner 40a, 40b, etc. The owner keeps track of how many references there currently are to its memory. When no references exist, the owner may free or release its memory, return it to some cache, etc.

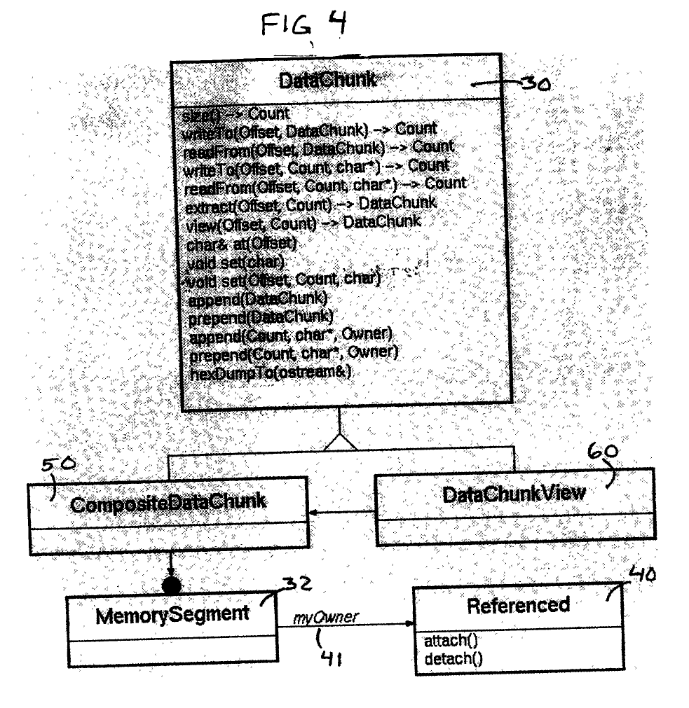

As shown in FIG. 4, a Data Chunk can be either a Composite Data Chunk 50 or a Data Chunk View 60, the latter being a fast-to-create Data Chunk, which represents a portion of another Data Chunk. A Composite Data Chunk consists of zero or more memory segments. Each memory segment points out a piece of physical RAM memory as well as an owner to that piece of memory, as previously described.

To make sure that memory, which is part of a Data Chunk, will not be prematurely released or reused, each of the memory segments making up a Data Chunk has an owner, e.g. an object created by one of the program processes in the dedicated network server. This owner may count the number of references currently existing to its memory and thus decide, whether it is being used by another user, e.g. some program processes in the dedicated network server, or whether it may be reused.

As mentioned above, there are two types of Data Chunks; Composite (normal) and View. Composite Data Chunks (represented by the reference numeral 50 in the drawings) are those normally used and are capable of performing all operations available with the memory management system according to the invention. Data Chunk Views (reference numeral 60) may be regarded as a simpler version of a “real” (i.e. Composite) Data Chunk. A Data Chunk View identifies or points out a portion of another Data Chunk. The reason why Data Chunk Views are provided is that they are often faster to create than normal Data Chunks. The draw-back of a Data Chunk View is that no new data may be appended or prepended to it.

Preferably, accesses to the data provided by a Data Chunk should be done in large chunks, since byte-wise accesses, for example, are not efficient. The best way to use Data Chunks is to prepare data and then add the data to the Chunk in one large piece. To add “empty” memory to a Data Chunk and then alter it is often inefficient.

When data arrives as a Data Chunk to a user process in the dedicated network server, that data has to be decoded in some way. Such decoding is regarded to be trivial to a man skilled in the art, and hence the subject will not be further discussed herein.

In FIG. 4, a data model of a preferred embodiment of a memory management system according to the present invention is illustrated. Each of the memory management objects or Data Chunks 30 described above comprises a set of methods for use as an interface “upwards” to the users (program processes) as well as “downwards” to the physical RAM memory. As previously mentioned, each Data Chunk 30 may be either a Composite Data Chunk 50 or a Data Chunk View 60. A Composite Data Chunk comprises a number of logical memory segments 32, which according to FIG. 3 comprise links to the underlying scattered segments 22a, 22b, etc., of the physical memory 20 as well as links to an owner object 40, referred to as Referenced in the drawings and in the usage examples below. The owner object 40 comprises methods for reserving and releasing memory segments.

Now, a set of usage examples will be described for the memory management system according to the invention and the memory management objects (Data Chunks) contained therein. The usage examples are presented as fragments or skeletons of program code, which is written according to a syntax bearing close resemblance to the C++ or Java syntax and hence should be readily understood by a man skilled in the art without any further explanations, apart from the ones given in the code below.

1. Create a new Data Chunk
Pointer<DataChunk> aChunk = DataChunk:create ( );
// A new empty Data Chunk has been created
2. Add data to a Data Chunk
Pointer<DataChunk> aChunk = . . . ;
char* someData = . . . ,

| | |
|---|---|
| Referenced& someOwner = . . . ; | // or more probably a subclass to |
| | // Referenced. |

aChunk−>append (34, someData, someOwner);
// append 34 bytes pointed out by someData to aChunk. someData is
// owned by someOwner.
aChunk−>prepend (34, someData, someOwner);
// prepend 34 bytes to aChunk
Pointer<DataChunk> anotherChunk = . . . ;
. . .
aChunk−>append(anotherChunk);
// append the entire anotherChunk to aChunk
3. Extract a Data Chunk from another
Pointer<DataChunk> aChunk = . . . ;
. . .
Pointer<DataChunk> anotherChunk = aChunk−>extract (3, 27);
// anotherChunk will point out 27 bytes of the same data as a Chunk
// beginning with byte at offset 3.
anotherChunk−>append (. . .
// more data may be appended (or prepended) as anotherChunk is
// a ‘real’ Data Chunk.
4. Create a view of a Data Chunk
Pointer<DataChunk> aChunk = . . . ;
. . .
Pointer<DataChunk> anotherChunk = aChunk−>view (3, 27);
// anotherChunk is a view that will point out 27 bytes of the same
// data as aChunk beginning with byte at offset 3 by using aChunk.
anotherChunk−>append (. . . // <−−− ERROR
// This is not allowed as anotherChunk is a view.
5. Copy data to, from and between Data Chunks
Pointer<DataChunk> aChunk = . . . ;
Pointer<DataChunk> anotherChunk = . . . ,
char* someMemory = . . . ;
aChunk−>writeTo (3, 27, someMemory);
// write 27 bytes starting at offset 3 from aChunk to someMemory
anotherChunk−>readFrom(0, 12, someMemory);
// read 12 bytes from someMemory to anotherChunk starting at offset
// 0.
aChunk−>writeTo (12, anotherChunk);
// write anotherChunk−>size ( ) bytes of data from aChunk starting at
// offset 12 into aChunk to anotherChunk.
aChunk−>readFrom (12, anotherChunk);
// read anotherChunk−>size ( ) bytes of data from anotherChunk
// (i.e. the entire anotherChunk) to aChunk starting at offset 12
// into aChunk.
6. Display the contents of a Data Chunk
Pointer<DataChunk> aChunk = . . . ;
. . .
aChunk−>hexDumpTo (cout);
// display the contents of aChunk on cout.
// This is what it may look like:
DataChunk: 138 bytes:
0000: 22 57 65 6c 6c 22 2c 20 73 61 69 64 20 74 68 65 “Well”, said the
0010: 20 53 6f 66 74 77 61 72 65 20 45 6e 67 69 6e 65 Software Engine
0020: 65 72 2c 20 22 42 65 66 6f 72 65 20 77 65 20 64 er, “Before we
0030: 6f 20 61 6e 79 74 68 69 6e 67 2c 20 49 20 20 74 do anything, I t
0040: 68 69 6e 6b 20 77 65 20 73 68 6f 75 6c 64 20 70 hink we should
0050: 75 73 68 20 74 68 65 20 63 61 72 20 62 61 63 6b push the car
0060: 20 75 70 20 74 68 65 20 72 6f 61 64 20 61 6e 64 back up the
0070: 20 73 65 65 20 69 66 20 69 74 20 68 61 70 70 65 road and see if
0080: 6e 73 20 61 67 61 69 6e 2e 22 it happens

again.”

DataChunk end
7. Dangerous memory
char someData[someSize];
// fill someData with useful data
Pointer<DataChunk> aChunk = DataChunk:create ( );
aChunk−>append(someSize, someData);
// append WITHOUT an owner! => its contents will be invalid as this
// scope is left.
fibble (aChunk);
// dangerous if fibble direct or indirect saves aChunk, as aChunks
// contents will be invalid as this scope is left.
return;
// here someData goes out of scope and may at any time be
overwritten.

8. Memory Reference Management

As previously mentioned, each physically non-contiguous memory segment is assigned an owner object. The owner object has an attach( ) method, which is called each time another object or program process makes a reference to (“uses”) the memory segment, as well as a detach( ) method, which is called by said another object or program process when it stops using the memory segment. Hence, the owner object keeps track of the number of references to its memory segment and fully controls the use of the memory segment. Depending on the application, when there are no longer any references to the memory segment, the owner object may release it, e.g. free it or make it available for reuse. Further details are given in the usage examples below.

void
Owner :: attach ( )
{
my count++;
}
void
Owner :: detach ( )
{
if( --myCount == 0)
{
// free or reuse memory
}
}
// Exemplary implementation of DataChunk :: append ( ):
void
DataChunk :: append( Count theSize, char* theData, Referenced& theOwner
)
{
// . . . handle some special cases
MemorySegment* aSegment = new MemorySegment ( theData, theSize,
theowner );
myLastSegment->append( aSegment );
myLastSegment=aSegment;
}
// Called when a memory segment is created:
MemorySegment :: MemorySegment ( char* theData,

Count theSize,
Referenced& theOwner )

myData ( theData ),
mySize ( theSize ),
myOwner ( theOwner ),
myNextSegment ( 0 )
{
myOwner.attach ( );
}
// Called when the memory segment is “destroyed”
MemorySegment ::˜MemorySegment ( )
{
myOwner.detach ( );
}

The present invention has been described above with reference to a few embodiments or examples, but it is to be understood that the invention shall in no way be restricted to the specific embodiments disclosed in the foregoing. On the contrary, the present invention shall only be limited by the scope of the appended patent claims.

What is claimed is:

1. A digital memory management system for providing access to a digital memory (20) from at least one program process executing in an operating system for at least one digital processor, characterized by
at least one memory management object (30, 50, 60), comprising a mapping structure (32a, 32b) for mapping a plurality of physically non-contiguous memory segments (22a, 22b) into a logically contiguous memory block, each of said physically non-contiguous memory segments being provided with a reference (41) to an owner (40, 40a, 40b), of the respective memory segment;
at least one method for providing random access for said at least one program process to said logically contiguous memory block; and
at least one memory reference handling method for monitoring the number of references from said at least one program process to each respective physically non-contiguous memory segment, said at least one memory reference handling method being arranged to release any of said physically non-contiguous memory segments, when or if it is found not to be in use by any of said at least one program process.

2. A digital memory management system according to claim 1, characterized in that said owner (40; 40a, 40b) of each respective physically non-contiguous memory segment is realized as an owner object, comprising at least one method for incrementing the number of references to the memory segment, and
at least one method for decrementing the number of references to the memory segment, said method being arranged to release the memory segment, if the number of references equals zero.
